(19) United States
(12) Patent Application Publication
(10) Pub. No.: US 2024/0349936 A1
(43) Pub. Date: Oct. 24, 2024

(54) AUTOMATIC MACHINE FOR PREPARING INFUSION BEVERAGES AND METHOD FOR CLEANING SUCH AN AUTOMATIC MACHINE

(71) Applicant: Bogdan Krinitchko, Zurich (CH)

(72) Inventor: Bogdan Krinitchko, Zurich (CH)

(21) Appl. No.: 18/574,696

(22) PCT Filed: Jul. 12, 2022
(86) PCT No.: PCT/EP2022/069520

§ 371 Date: Dec. 27, 2023

(30) Foreign Application Priority Data
Jul. 13, 2021 (CH) CH070046/2021

(51) Int. Cl. A47J 31/60; A47J 31/06; A47J 31/44; A47J 31/52; B08B 9/08

(52) U.S. Cl. CPC A47J 31/60; A47J 31/0605; A47J 31/0615; A47J 31/4478; A47J 31/52; B08B 9/0804; B08B 2209/08

(57) ABSTRACT

An automatic machine for preparing infusion beverages has a housing and an infusion vessel inserted or insertable into the housing. The infusion vessel has a lower inner surface and a lateral inner surface, which together define an interior space serving to receive infusion material and water, as well as an outlet opening. For discharging the infusion beverage from the infusion vessel, an outlet conduit is connected or connectable to the outlet opening. An outlet valve is provided to open or close, the discharge of the infusion beverage through the outlet conduit. The automatic machine also has an inlet device for admitting a liquid into the infusion vessel, which is configured in such a way that the liquid flows uniformly over the lateral inner surface into the interior of the infusion vessel. A method for the automatic cleaning of an infusion vessel used for the preparation of an infusion beverage is also disclosed.

### BACKGROUND

The present invention relates to an automatic machine for preparing infusion beverages. The machine is used to prepare infusion beverages, such as in particular tea. Furthermore, a method for the automatic cleaning of an infusion vessel, which is used to prepare an infusion beverage is disclosed.

### DESCRIPTION OF RELATED ART

Normally, to prepare a cup of tea, a bag of tea or tea powder is placed in hot water in a strainer container or hot water is poured over it, and after a certain brewing time the tea is ready to be served and drunk as a beverage. This preparation usually consumes an unnecessary amount of electrical energy, because very often more water is heated than the amount actually required for a cup of tea, and tea preparation often involves laborious handling: firstly, water must be put into a vessel in which it is heated, then the heated water must be added to the tea, which is usually in a tea bag, which in turn is in a boiling vessel, and then, after the tea is ready, the tea bag must be removed from the boiling vessel. Only then can the tea be enjoyed as a beverage.

There are also automatic tea makers. These heat the water to the boiling point in a vessel and the resulting steam then passes through a steeping vessel in which the tea is contained in a permeable capsule. This type of tea preparation differs from the classic method of preparation, because the tea has little time to brew and the tea is emptied directly into a drinking recipient as a beverage. This automatic preparation does not correspond to the “classic tea preparation method” because the tea is given little time to brew or steep. As a result, losses in taste have to be accepted. Due to the heating and the necessary subsequent evaporation of the water, this variant also consumes an unnecessary amount of electrical energy. In contrast, in the classic tea preparation method, the water is usually not heated all the way to the boiling point, as this has proven to be clearly advantageous not only in terms of energy consumption, but also in terms of the development of the aroma.

For example, EP 1 808 110 A1 discloses a tea machine in which heated water is introduced into an upper vessel where it comes into contact with tea or coffee. The tea or coffee is held in a filter which is inserted into the upper vessel from above. After a certain time, the infusion prepared in this way passes via an outlet line into a lower vessel, where it is kept warm.

Other generic machines for preparing infusion beverages are disclosed, for example, in the documents WO 99/34716 A1, U.S. Pat. Nos. 6,964,222 B1, 7,717,026 B1, US2007/017380 A1, US2015/182063 A1, U.S. Pat. No. 9,820,607 B2. U.S. Pat. No. 7,717,026 B1 shows a brewing device for hot beverages, which has a rotatable distribution element for distributing water onto the surface of a beverage located in a filter holder.

Document US2007/017380 A1 shows a manifold that introduces hot water at multiple points onto the surface of a coffee powder placed in a filter to achieve optimal extraction for a high quality coffee beverage. Document US2015/182063 shows a brewing device that can be used alternatively for tea or coffee. By using a coffee receiving vessel containing a coffee filter and an additional tea receiving vessel containing a tea filter, the different brewing processes for these two types of hot beverages are considered. In particular, an additional valve is provided for the preparation of tea, which closes the outlet opening according to the desired brewing time of the tea. The hot water can be supplied to the coffee powder located in the coffee receiving vessel or alternatively to the tea bag or also tea leaves located in the tea receiving vessel via a plurality of inlet openings. Also disclosed in document U.S. Pat. No. 9,820,607 B2 is a tubular liquid distributor for distributing hot water to a particulate infusion material for extracting a hot beverage. For better distribution of the hot water onto the infusion material, the tubular liquid distributor includes a plurality of openings arranged at an angle with respect to the vertical direction.

Document WO 2016/041835 A1 stems from the same inventor as the previous document, in which another generic automatic machine for preparing infusion beverages is disclosed.

In the case of automatic machines for preparing infusion beverages, the infusion vessel in which the tea or herbs are infused and the corresponding beverage is prepared must be cleaned regularly. Since this is cumbersome and often forgotten, stubborn deposits often form on the inner surfaces of the infusion vessel over time. Such deposits can only be removed by hand with difficulty and considerable effort. They also distort the taste of the prepared beverage, which is particularly unsatisfactory when using different types of tea or herbs.

### SUMMARY OF THE INVENTION

It is an object of the present invention to provide an easy-to-use automatic machine for preparing infusion beverages, in which the above-mentioned problem of cleaning is reduced. In particular, it is an object of the invention to enable cleaning of the infusion vessel before, during or after preparation of the infusion beverage without removing the infusion vessel for cleaning purposes and without using cleaning agents. The cleaning of the infusion vessel can thus already take place when the brewing material is still in the holding sieve. To solve this task, an automatic machine for preparing infusion beverages is proposed as indicated in claim 1. Furthermore, a method for automatically cleaning an infusion vessel serving for the preparation of an infusion beverage is disclosed in claim 16. Advantageous embodiments of the invention are indicated in the dependent claims.

The present invention thus provides an automatic machine for preparing infusion beverages, comprising a housing; an infusion vessel inserted or insertable into the housing and having a lower inner surface and a lateral inner surface which together define an interior space for receiving infusion material and water, and an outlet opening; an outlet conduit connected or connectable to the outlet opening for discharging the infusion beverage from the infusion vessel; and an outlet valve for blocking and unblocking discharge of the infusion beverage through the outlet conduit.

The automatic machine also has an inlet device for admitting a liquid, such as water in particular, into the infusion vessel, which is configured such that the liquid flows uniformly over the lateral inner surface into the interior space of the infusion vessel. By allowing the liquid to flow evenly over the lateral inner surface of the infusion vessel, the inlet device removes residues and deposits of the previously used infusion material from the inner surfaces of the infusion vessel in a very simple but efficient manner. For example, the liquid can be introduced into the infusion vessel through the inlet device immediately after preparation of an infusion beverage in a cleaning process provided specifically for this purpose. In particular, it can be provided that such a cleaning process is carried out in each case before the automatic machine is switched off. The liquid can be, for example, a cleaning liquid or drinking water. Alternatively or additionally, the water used to prepare the beverage can be introduced into the infusion vessel through the inlet device and via the lateral inner surface of the infusion vessel. In this way, self-cleaning already takes place during beverage preparation and water and energy consumption can be minimized.

By a uniform inflow of liquid over the lateral inner surface of the infusion vessel it is meant that the liquid, when introduced into the infusion vessel, covers a large portion of that part of the lateral inner surface of the infusion vessel which comes into contact with the infusion material and/or with the infused beverage during beverage preparation. Preferably, a circulating liquid film is formed in the process, so that the lateral inner surface is cleaned from dirt, deposits, etc. in a circulating manner. Advantageously, this liquid film covers a predominant major part, even more advantageously the entirety, of the lateral inner surface. In particular, the inlet device comprises at least one inlet opening which is aligned with the lateral inner surface so that, in the operating state, the liquid flowing from the inlet opening to the lateral inner surface can wet the lateral inner surface before it flows into the interior space of the infusion vessel.

According to an embodiment, the inlet device comprises a single inlet opening. According to an embodiment, the inlet device comprises a plurality of inlet openings that can be activated one after the other.

According to an embodiment, the lateral inner surface has a wetting with liquid of 60% up to and including 100%. Preferably, the lateral inner surface has a wetting with liquid that is in the range from 70% up to and including 100%.

In particular, the lateral inner surface is wetted in such a way that all the lateral inner surface can be covered with the liquid simultaneously. In other words, the lateral inner surface is wetted with liquid at the same time. If, for example, the lateral inner surface is configured as a cylinder jacket, the entire cylinder jacket is wetted at the same time. In this way, the lateral inner surface can be cleaned particularly quickly and thoroughly. In addition, the lower inner surface can be covered with the liquid at the same time.

According to an embodiment, the housing includes a plurality of inlet devices.

Preferably, the inlet device is also configured in such a way that the liquid also flows uniformly over the lower inner surface into the interior of the infusion vessel. Advantageously, a film of liquid is formed which covers a major part, and even more preferably the entirety, of the lower inner surface of the infusion vessel.

The lower inner surface of the infusion vessel preferably, but not necessarily, has a circular or oval outer contour. The lateral inner surface preferably, but also not necessarily, has a circular cylindrical or an oval cylindrical shape. In the latter case, the lateral inner surface has an oval shape in cross-sectional view. With such shaped infusion vessels, less dirt is deposited on the inner surfaces. They are also easier to clean.

The outlet opening is preferably arranged along the direction of gravity at the lowest point or at one of the lowest points of the infusion vessel. The finished infusion beverage can thus flow out of the infusion vessel easily. Preferably, the infusion vessel has no further openings at the bottom, so that the infusion beverage can flow out exclusively via the outlet opening when the infusion vessel is inserted in the housing as intended.

The infusion vessel preferably has a connection piece which forms the outlet opening. The connection piece, which advantageously projects downwards from the infusion vessel, is preferably used to connect the outlet conduit thereto. The outlet conduit can in particular be formed by a flexible hose. Alternatively, the connection piece itself can form the outlet line, or the outlet line can be firmly attached to the infusion vessel directly in the vicinity of the outlet opening, also in the form of a flexible hose.

The outlet valve is configured to retain the water in the interior of the infusion vessel during preparation of the infusion beverage or to drain it from the infusion vessel after preparation is complete. The outlet valve can thus be used to block or unblock the outlet conduit.

The material to be infused can be tea or herbs in particular. In the case of tea, for example, it can be introduced into the infusion vessel in the form of tea powder or tea bags and then infused with water. Depending on the type of tea, the water preferably has a correspondingly adapted temperature. When preparing iced tea, for example, the water can also be cooled. However, the use of the automatic machine is basically not limited to tea and herbs. For example, any fruits or, more generally, plants and plant parts can be infused. For example, pieces of ginger, peppermint leaves, lemon or orange slices and any combination thereof can be placed in the infusion vessel and infused with hot or cold water. The machine can also be used to prepare syrup drinks. In this case, the syrup concentrate would form the infusion material. It is also conceivable to use coffee as the infusion material.

For preparation, the infusion material, in whatever form, for example as powder or in a bag, is placed in the infusion vessel. A preparation program set by the user or selected automatically is then started. Depending on the embodiment, the user can select and/or configure the preparation program either directly on the automatic machine or remotely via his smartphone. During preparation, water, which has preferably been tempered beforehand, is introduced into the infusion vessel and the infusion material is infused with it accordingly.

Alternatively, the water can also be tempered in the infusion vessel. By selecting the preparation program, for example, the required amount of water, the infusion temperature of the water and the preparation time or infusion time are determined. After the automatic machine has completed the selected preparation program, the ready-prepared infusion beverage is preferably drained fully automatically into a suitable drinking vessel. Advantageously, once the user has placed the infused beverage in the automatic machine and started the program, the user does not have to worry about preparing it or serving the infused beverage. After preparation, the infused beverage is available in the cup ready to drink. The automatic machine can be configured to signal the end of preparation acoustically and/or visually.

In particular, the specified automatic machine has the advantage of consuming a minimum amount of electrical energy and can save handling efforts. The preparation is thus facilitated for the user and also optimized in terms of time. At the same time, it is still possible for the automatic machine to deliver infused beverages and, in particular, tea beverages of the same high quality as if they had been infused or, in the case of tea beverages, brewed in the classical manner. In a particularly preferred embodiment, the automatic machine can be remotely controlled from any location.

Preferably, the automatic machine comprises a holder for the infusion material, which is configured to be positioned in the interior of the infusion vessel and serves to hold the infusion material during infusion. In particular, the holder is preferably configured that both the infusion material and the holder itself are arranged at a distance from the lower inner surface and the lateral inner surface of the infusion vessel during infusion. In other words, the holder is configured preferably be positioned in the interior space of the infusion vessel during intended use exclusively in such a way that both the infusion material held therein and the holder itself are arranged at a distance from the lower inner surface and the lateral inner surface of the infusion vessel. Such a configuration of the infusion vessel has the considerable advantage that, for example, during cleaning or draining of the infusion beverage, any residues of the infusion material and other particles can run off along the inner surfaces of the infusion vessel without any obstacles. In addition, no or less turbulence is formed in the draining liquid, which also contributes to better removal of residues from the infusion vessel. The combination of the uniform flow of liquid over the inner surface into the interior space of the infusion vessel and the spacing of the holder and the infusion material held therein from the inner surfaces of the infusion vessel thus leads to a considerable reduction in the cleaning effort.

The holder can be, for example, a small plate attached to the side of the lower end of a vertical holding rod. In this case, for example, a tea bag can be positioned on the plate and lowered into the infusion vessel with the aid of the holding rod. In a particularly preferred embodiment, however, the holder is a retaining sieve which has a base and a circumferential side wall extending upwardly from the base. The bottom and/or the side wall preferably have holes or perforations to allow the water to pass through during the infusion. Preferably, the bottom and/or the side wall are sheets which are provided with holes or perforations which are advantageously produced with the aid of a laser and preferably each have a diameter of at most 2 mm, more preferably at most 1 mm. When used as intended, the retaining sieve can preferably be positioned exclusively in the interior of the infusion vessel in such a way that the bottom and the side wall of the retaining sieve are arranged at a distance from the lower inner surface and the lateral inner surface of the infusion vessel.

The retaining sieve can be made of metal or plastic, in particular silicone. However, it can also be made of paper, for example.

Preferably, one or more holding arms are attached to the holder, which serve to hold the holder in the infusion vessel. For example, the holding arms can be configured to rest on an upper side, in particular an upper edge, of the infusion vessel.

In order to ensure the spacing of the holder from the lateral inner surface and/or the lower inner surface of the infusion vessel, one or more spacers are preferably attached to the holder. The spacers can in particular be attached to or formed by the aforementioned holding arms.

The infusion vessel preferably has a connection piece which forms the outlet opening and serves to connect the outlet conduit.

In order to allow thorough cleaning of the infusion vessel from time to time, or even to replace it if necessary, the infusion vessel is preferably easy to remove from the housing. Therefore, advantageously, no tools are required.

In order to further simplify handling and/or to improve beverage preparation and/or to prevent incorrect manipulation, the automatic machine preferably has one or more sensors which are connected to a control unit used to control the preparation program.

For example, the machine can have an infusion vessel sensor for detecting whether the infusion vessel is correctly inserted in the housing. The control unit can then be configured, for example, to emit an acoustic or visual signal and/or to stop or prevent beverage preparation if the infusion vessel sensor detects that the infusion vessel has not been inserted correctly in the housing. The infusion vessel sensor is preferably a mechanical or electromechanical sensor.

To prevent heat from escaping and dirt particles from entering, the automatic machine preferably has a lid for closing the infusion vessel. Closing the infusion vessel with the lid is advantageously also possible when the holder is inserted in the infusion vessel. Preferably, a lid sensor is provided for detecting whether the lid is in an open or closed state. The control unit can be configured to emit an acoustic or visual signal and/or to stop or prevent beverage preparation if the lid sensor detects that the lid is open.

The inlet device is preferably manufactured as a whole in a single piece and advantageously by injection molding from a plastic material. However, it is also possible for the inlet device to have a plurality of components which can be made from a plastic material by injection molding.

In a particularly preferred embodiment, the inlet device has a plurality inlet openings for admitting the liquid into the infusion vessel. These are preferably arranged along the lateral inner surface of the infusion vessel and in particular preferably at uniform distances from one another. The liquid can then flow from the inlet openings circumferentially over the lateral inner surface into the infusion vessel. For this purpose, the inlet device can have a circumferential annular space which serves to distribute the liquid to the inlet openings. In this case, the inlet openings each open into the annular space.

The inlet openings are preferably each bordered by a short tube section which defines the direction of the liquid flowing into the infusion vessel. The tube section can form a nozzle, for example to atomize the liquid as it enters the infusion vessel.

A particularly efficient cleaning effect with less liquid consumption results if the inlet device is configured in such a way that the liquid enters spirally over the lateral inner surface of the infusion vessel. For this purpose, in particular the tube sections surrounding the inlet openings can be aligned accordingly.

To enable easy removal of the infusion vessel from the housing, the inlet device can advantageously be opened and closed relative to an upper side of the infusion vessel.

Preferably, an inlet device sensor is provided to detect the position of the inlet device in relation to the infusion vessel. The control unit can be configured to emit an acoustic or visual signal and/or to stop or prevent beverage preparation if the inlet device sensor detects that the inlet device is not correctly positioned on the infusion vessel.

The inlet device can simultaneously form a lid for closing the infusion vessel.

The infusion vessel is preferably made of glass, ceramic, in particular porcelain, or a coated material, and in particular preferably manufactured as a single piece. The cleaning effort can thus be further reduced. Preferably, the infusion vessel is open at the top.

The automatic machine can also have a beverage recipient sensor for detecting whether a beverage recipient is arranged in or on the automatic machine in such a way that the infused beverage can be discharged through the outlet conduit into the beverage recipient. The control unit can then be configured in particular to emit an acoustic or visual signal and/or to stop or prevent the discharge of the prepared beverage if the beverage recipient sensor detects that no beverage recipient is present or that it is not correctly positioned.

One or more weight sensors can be provided to enable weighing of the infusion material. The control unit can then be configured in particular to automatically adapt the preparation program to the quantity of the infusion material. Preferably, the weight sensor(s) is/are arranged in such a way that they are configured to measure the weight of the holder including the infusion material accommodated therein when the holder is inserted into the infusion vessel.

In order to enhance the extraction of the flavoring substances from the infusion material and/or to improve the mixing of the infusion material with the water during infusion, the automatic machine can additionally have a processing device for mechanically processing the infusion material in the infusion vessel. The processing device can be, in particular, a plunger which can be pressed against the bottom of the retaining sieve to extrude the infusion material. The processing device can be manually operated by the user or automatically by means of a motor.

For tempering the water and/or the infusion beverage, the automatic machine preferably has a heating device and/or a cooling device, in particular a cryostat. The heating and/or cooling device can be arranged in the vicinity of a water tank or within a supply conduit or the outlet conduit. It is also conceivable that the heating and/or cooling device serves to heat or cool the infusion vessel or the beverage recipient. Preferably, one or more temperature sensors are provided to control the temperature of the water, especially in the region of the heating and/or cooling device. Particularly good control and regulation of the water temperature is possible if the heating and/or cooling device has an input temperature sensor that measures the water temperature as it enters the heating and/or cooling device, and an output temperature sensor that measures the water temperature as it exits the heating and/or cooling device. The automatic machine also preferably has a pump for conveying the water and/or liquid to the infusion vessel, in particular to the inlet device.

The automatic machine can have an additional preparation unit which makes it possible to add an additional medium, such as milk or syrup concentrate, to the infusion beverage. The additional preparation can in particular have an additional tank which serves to hold the additional medium. A heating and/or cooling device may be provided to temper the additional medium. Furthermore, the additional preparation may comprise a compressed air pump, a compressed air connection and/or a fluid pump to convey the additional medium.

The present invention further relates to a method for the automatic cleaning of an infusion vessel serving for the preparation of an infusion beverage, wherein the infusion vessel has a lower inner surface and a lateral inner surface, which together delimit an interior space serving for the accommodation of infusion material and water, the method being carried out in particular by means of an automatic machine as indicated above and comprising at least the following step: introducing a liquid, such as in particular water, into the infusion vessel in such a way that the liquid flows uniformly and preferably spirally over the lateral inner surface into the interior space of the infusion vessel. Advantageously, the inflowing liquid is heated water with a temperature of preferably at least 40° C., even more preferably at least 60° C. and most preferably at least 70° C.

### BRIEF DESCRIPTION OF THE DRAWINGS

Preferred embodiments of the invention are described below with reference to the drawings, which serve for explanatory purposes only and are not to be construed restrictively. It is shown in the drawings:

FIG. 1 a schematically represented central cross-sectional view of the infusion vessel with a retaining sieve inserted therein and an inlet device of an automatic machine arranged there above according to a first variant of the invention;

FIG. 2 a schematically represented central cross-sectional view of the infusion vessel with a retaining sieve inserted therein and an inlet device of an automatic machine arranged there above according to a second variant of the invention;

FIG. 3 a schematically represented central cross-sectional view of the infusion vessel with a retaining sieve inserted therein and an inlet device of an automatic machine arranged there above according to a third variant of the invention;

FIG. 4 a schematically represented central cross-sectional view of the infusion vessel with a retaining sieve inserted therein and an inlet device of an automatic machine arranged there above according to a fourth variant of the invention;

FIG. 5 a schematically illustrated central cross-sectional view of an automatic machine according to the invention according to a first embodiment;

FIG. 6 a view from below of the retaining sieve and the inlet device arranged there above of the automatic machine of FIG. 5;

FIG. 7 a schematically represented central cross-sectional view of the region of the infusion vessel of the automatic machine of an automatic machine according to a second embodiment, with the opened lid and inlet device;

FIG. 8 a schematically represented central cross-sectional view of the region of the infusion vessel of an automatic machine according to a third embodiment, with the opened lid and inlet device;

FIG. 9 a schematically represented central cross-sectional view of the region of the infusion vessel of an automatic machine according to the invention according to a fourth embodiment;

FIG. 10 a schematically represented central cross-sectional view of the region of the infusion vessel of an automatic machine according to the invention according to a fifth embodiment;

FIG. 11 a schematically represented central cross-sectional view of an automatic machine according to the invention according to a sixth embodiment;

FIG. 12 a schematically represented central cross-sectional view of an automatic machine according to the invention according to a seventh embodiment;

FIG. 13a a schematic central cross-sectional view of the outlet valve in the blocked state of an automatic machine according to the invention;

FIG. 13b a view of the outlet valve of FIG. 13a in the open state;

FIG. 14 a schematic central cross-sectional view of the outlet valve in the locked state of another automatic machine according to the invention; and

FIG. 15 a schematically represented central cross-sectional view of the region of the infusion vessel of an automatic machine according to the invention with a processing device for mechanical processing of the infusion material in the infusion vessel.

### DETAILED DESCRIPTION

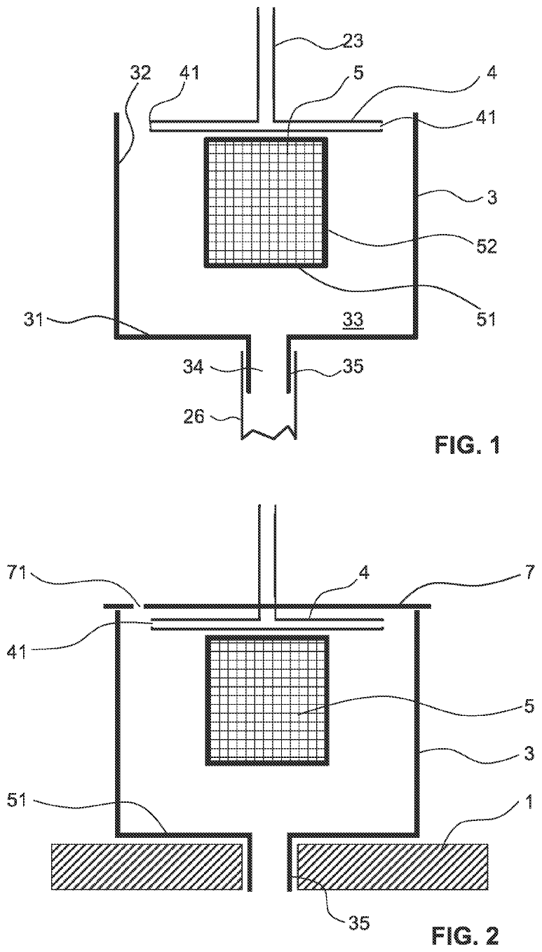

FIGS. 1 to 15 described below show various embodiments of automatic machines according to the invention for preparing infusion beverages and parts thereof. Elements from different embodiments, but with the same or similar function, are each provided with the same reference numerals. As far as possible, features of different embodiments can of course be transferred to other embodiments in any way, i.e., the different embodiments can be combined with one another in any way.

FIG. 1 shows a schematic cross-sectional view of an infusion vessel 3 with a retaining sieve 5 inserted therein and an inlet device 4 arranged there above. The infusion vessel 3 has a circular bottom here, which forms a lower inner surface 31. A cylindrical side wall which forms a lateral inner surface 32 extends circumferentially from the bottom. In addition, a connection piece 35 extends centrally downwardly from the bottom at a short distance in the direction of gravity. The connecting piece 35 forms an outlet opening 34. The lower inner surface 31 and the lateral inner surface 32 together delimit an interior space 33 of the infusion vessel 3. The entire infusion vessel 3 is preferably configured in a single piece and is advantageously made of glass, ceramic, or a coated plastic.

The retaining sieve 5 is inserted into the interior space 33 in such a way that it does not contact either the lower inner surface 31 or the lateral inner surface 32 of the infusion vessel 3. The retaining sieve 5 has a circular bottom 51, from which a cylindrical side wall 52 extends circumferentially in an upward direction. The side wall 52 and advantageously also the bottom 51 have a plurality of openings and/or perforations which are dimensioned in such a way that water can pass through, but not the infusion material held in the retaining sieve. The retaining sieve 5 thus serves as a holder for the infusion material during the preparation of the beverage and in particular during the infusion. The infusion material can be accommodated in the retaining sieve 5 in any form, for example in powder form or in the form of leaves or packed in a bag. The retaining sieve 5 can be held, for example, on the inlet device 4 or on another element of the automatic machine.

The inlet device 4 is connected to a water conduit 23 and is used to introduce water into the interior space 33 of the infusion vessel 3 in order to infuse the infusion material held in the retaining sieve 5 for the purpose of preparing a beverage and/or to clean the infusion vessel 3. For this purpose, the inlet device 4 has one or more inlet openings 41 which are arranged in such a way that the water flows from these directly onto the lateral inner surface 32 of the infusion vessel 3 and flows therein evenly downwards into the interior space 33. In this way, residues, deposits and dirt particles are removed, which still adhere to the inner surfaces of the infusion vessel 3 from earlier beverage preparations.

An outlet conduit 26 is attached to the connection piece 35, which is formed here by a flexible hose. After preparation, the infusion beverage can be drained through the outlet conduit 26 into a beverage recipient located below.

In the variant shown in FIG. 2, a lid 7 is also provided with which the infusion vessel 3 can be closed. One or more openings 71 are provided in the lid 7 to allow steam or condensate to escape. Alternatively or additionally, there could also be a corresponding gap between lid 7 and infusion vessel 3 for this purpose. An additional sieve lid, not shown here, could be provided to close the retaining sieve 5. The infusion vessel 3 is inserted here with its connection piece 35 in a housing 1.

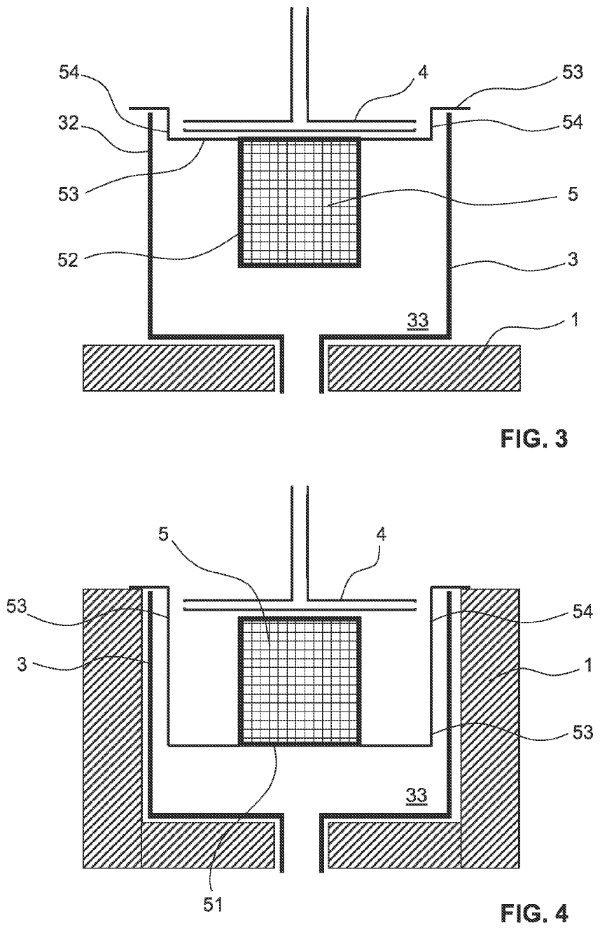

FIG. 3 shows a possible holder which ensures a spaced arrangement of the retaining sieve 5 relative to the inner surfaces 31, 32 of the infusion vessel 3 during the infusion process. Holding arms 53 are attached to the retaining sieve 5 for this purpose, each of which extends radially outwards and rests on an upper edge of the infusion vessel 3. The holding arms 53 are arranged in such a way that the water flowing into the infusion vessel 3 from the inlet device 4 is not obstructed.

The holding arms 53 each have a vertical section in the area of the lateral inner surface 32, which forms a spacer 54.

When the retaining sieve 5 is inserted in the infusion vessel 3 as intended, this ensures that it does not make contact with the inner surfaces 31 and 32. As a result, no contact point can form between the retaining sieve 5 and the infusion vessel 3 on which any particles can stick when water is introduced through the inlet device 4.

FIG. 4 shows a variant in which the holding arms 53 are attached to the bottom 51 instead of to the upper edge of the retaining sieve 5 as in FIG. 3. In addition, the infusion vessel 3 is surrounded here circumferentially by a wall of the housing 1.

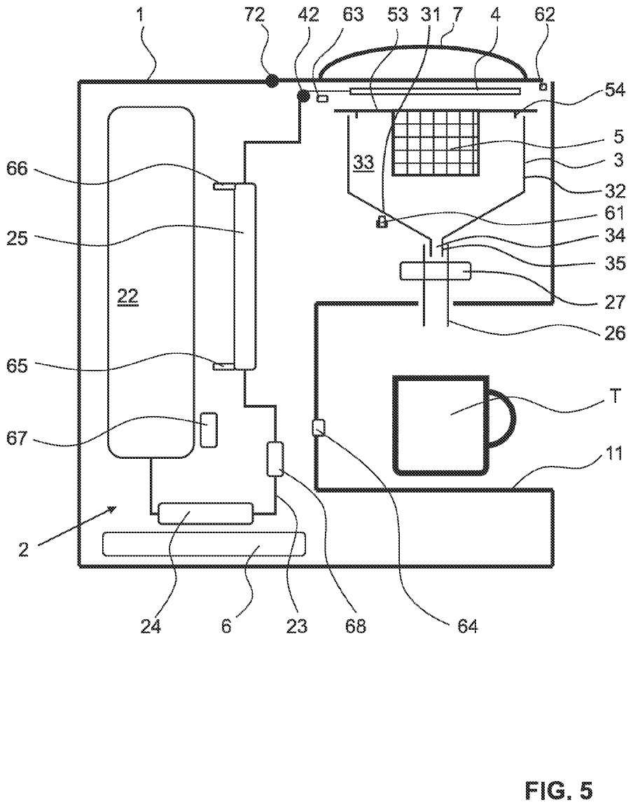

FIG. 5 schematically shows a central cross-sectional view through an automatic machine according to the invention for preparing infusion beverages. The automatic machine has a housing 1 which is generally C-shaped in cross-sectional view. The lower horizontally extending leg of the C-shaped configuration forms a storage surface 11 which is used for storing a beverage recipient T below the outlet conduit 26. The beverage recipient T serves to hold the prepared infusion beverage. The storage surface 11 is preferably formed by a plate permeable to liquids, i.e., provided with openings. A drip tray is preferably arranged below this plate.

FIG. 5 shows in particular a water treatment unit 2 of the automatic machine. The water treatment unit has in particular a water tank 22, a pump 24, a heating or cooling device 25 and the previously mentioned water conduit 23, which connects these elements to one another. The water tank 22, which is preferably easily removable from the housing 1, serves to hold and provide the water required for beverage preparation. Instead of the water tank 22 or in combination with it, a water connection can also be provided to continuously supply the automatic machine with water. Via the water conduit 23, the water tank 22 is connected to the pump 24, which serves to convey the water from the water tank 22 to the inlet device 4. The pump 24 may, but need not, be, for example, a diaphragm pump or a vibrating armature pump. The heating or cooling device 25 arranged between the pump 24 and the inlet device 4 within the water conduit 23 serves to temper the water before it enters the infusion vessel 3. The heating or cooling device 25 can comprise a heating element, such as a heating coil or a flow heater, and/or it can comprise a cooling device which serves to cool the water, for example for the preparation of iced tea.

From the infusion vessel 3, the ready-prepared infusion beverage passes via the outlet conduit 26 into the beverage recipient T positioned directly thereunder. With the aid of an outlet valve 27, the passage through the outlet conduit 26 for the liquid located in the infusion vessel 3 can be opened or closed as required. The automatic machine is preferably configured to keep the outlet valve 27 closed during the inflow of water into the infusion vessel 3 and during a subsequent reaction time, so that no liquid can escape through the outlet opening 34 of the infusion vessel 3. Once the infusion time has expired and the beverage preparation is complete, the outlet valve 27 can be automatically opened to drain the infused beverage into the beverage recipient T. The outlet valve 27 is preferably configured as a pinch valve, i.e., the passage through the flexibly designed outlet conduit 26 is closed by the latter by being mechanically compressed from the outside.

As can be seen in FIG. 5, the inlet device 4 and the lid 7 can each be opened and closed in relation to the infusion vessel 3. The infusion vessel 3 and the retaining sieve 5 inserted therein can thus be very easily removed from the housing. This makes it considerably easier to clean these components. A hinge 42 for the inlet device 4 and a hinge 72 for the lid 7 are provided for opening and closing.

In the embodiment shown in FIG. 5, holding arms 53 are attached to the retaining sieve 5, each of which extends outwardly in a horizontal direction from the upper edge of the side wall 52 and rests on the upper edge of the infusion vessel 3. In order to ensure that the side wall 52 of the retaining sieve 5 is circumferentially supported, downwardly projecting spacers 54 are provided on each of the undersides of the holding arms 53. From the inlet device 4, the water for beverage preparation also flows into the infusion vessel 3 in such a way that it flows over the lateral inner surface 32 and thereby removes any deposits and dirt residues from the inner surfaces 31, 32 of the infusion vessel 3.

The automatic machine shown in FIG. 5 also has a control unit 6 which is used to control, i.e., execute, the preparation program. For this purpose, the control unit 6 is connected at least to the pump 24, the heating or cooling device 25 and the outlet valve 27.

A user interface not shown in the figures may be provided, which enables the selection and configuration of the preparation program for the user. In particular, the user interface may comprise a touch screen and/or conventional rotary switches and buttons. Alternatively or additionally, the automatic machine can have a communication unit to communicate wirelessly with, for example, a smartphone. In this case, a smartphone app can serve as the user interface. The user interface of the automatic machine or the communication unit is connected to the control unit 6, which preferably has a CPU and at least one memory element for carrying out the control. The memory element advantageously enables individual parameterization and/or programming of the control unit 6. The individual programming enables the user to create a plurality of preparation programs for different types of tea, whereby the packages of the different types of tea can be recorded, for example, with a built-in digital camera or via the smartphone app and then displayed on the touchscreen or a display of the automatic machine. This makes it easier for the user to select his desired preparation program, which he has previously adapted to the different beverage types. The user then only needs to tap the image of the corresponding tea type package on the touchscreen or in the smartphone app and the correct preparation program is processed by the control unit 6 already from the start.

In order to facilitate the handling of the automatic machine, to avoid malfunctions and to further optimize the beverage preparation, the automatic machine preferably has a plurality of sensors, as shown in FIG. 5, which are connected to the control unit 6.

For example, a water tank sensor 67 can be provided to detect whether the water tank 22 is correctly inserted into the housing 1 and/or whether the water tank 22 is sufficiently filled with water. A flow meter 68 arranged within the water conduit 23 is used to measure the amount of water supplied to the infusion vessel 3 during beverage preparation. A lid sensor 62 and an inlet device sensor 63 can also be provided to detect whether the lid 7 and the inlet device 4 are correctly closed and positioned above the infusion vessel 3. Furthermore, an infusion vessel sensor 61 can be provided to detect whether the infusion vessel 3 is correctly inserted into the housing 1. A beverage recipient sensor 64 can be provided to detect whether a beverage recipient T is positioned below the outlet conduit 26 on the storage surface 11. In particular, mechanical or electromechanical sensors can be used for each of the above-mentioned sensors 61, 62, 63, 64 and 67. Alternatively, the use of, for example, optical sensors would also be conceivable. The control unit 6 is preferably configured to emit an acoustic or visual signal and/or to stop or prevent the preparation of the beverage depending on the signals received from the sensors 61, 62, 63, 64 and 67. In order to control the heating or cooling device 25 and to control the temperature of the water flowing into the infusion vessel 3, an inlet temperature sensor 65 and an outlet temperature sensor 66 are provided, which are arranged in the direction of flow at the beginning and end of the heating or cooling device 20, respectively.

As has already been mentioned, the water is introduced into the interior space 33 of the infusion vessel 3 by the inlet device 4 in such a way that it flows uniformly downwards over the lateral inner surface 32 to the lower inner surface 31. Due to the conical design of the lower inner surface 31 in the embodiment of FIG. 5, the water then flows uniformly from the lateral inner surface 32 over the lower inner surface 31 to the outlet opening 34. Dirt particles and deposits are thus removed from the inner surfaces 31, 32 of the infusion vessel 3.

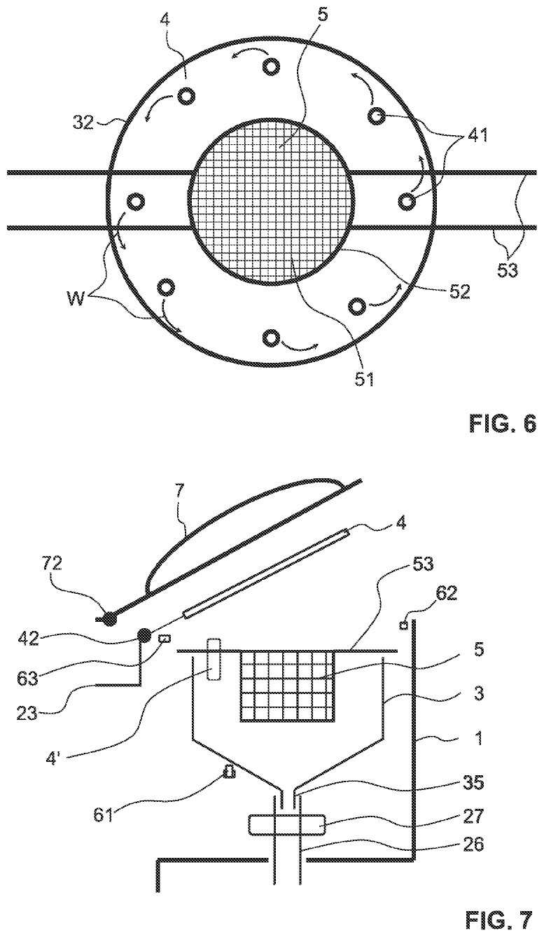

In order to effect such an introduction of the water into the infusion vessel 3, the inlet device 4, as shown in FIG. 6, has a plurality of inlet openings 41, which are arranged at regular intervals along the lateral inner surface 32 of the infusion vessel 3. Upstream, the inlet openings 41 preferably open into an annular space which serves within the inlet device 4 to distribute the water flowing from the water conduit 23 to the inlet openings 41. The inlet device 4 may therefore, in particular, have an annular configuration as a whole as can be seen in FIG. 6. As is also clearly visible in FIG. 6, the inlet openings 41 are preferably arranged in such a way that the water is neither influenced nor obstructed by the holding arms 53 when it enters the infusion vessel 3.

In order to achieve a particularly efficient cleaning of the infusion vessel 3 with less water consumption, the inlet device 4 is preferably configured to introduce the water into the interior space 33 in a spiral shape. In order to specify a corresponding direction of the water as it flows into the infusion vessel 3, the inlet openings 41 can each be surrounded by a short tube section. In FIG. 6, the spiral water flow W is illustrated by means of arrows.

FIG. 7 shows an embodiment which differs from that of FIG. 5 in that an additional inlet device 4′ is provided. While the additional inlet device 4′ can be used to introduce drinking water into the infusion vessel 3 for preparing the infusion beverage, the inlet device 4 can be provided specifically for cleaning processes and accordingly serve to introduce a cleaning liquid into the infusion vessel 3. However, the additional inlet device 4′ can also simply be used to enable the infusion vessel 3 to be filled more quickly when the beverage is being prepared. In contrast to FIG. 5, FIG. 7 also shows the inlet device 4 and the lid 7 in their open position.

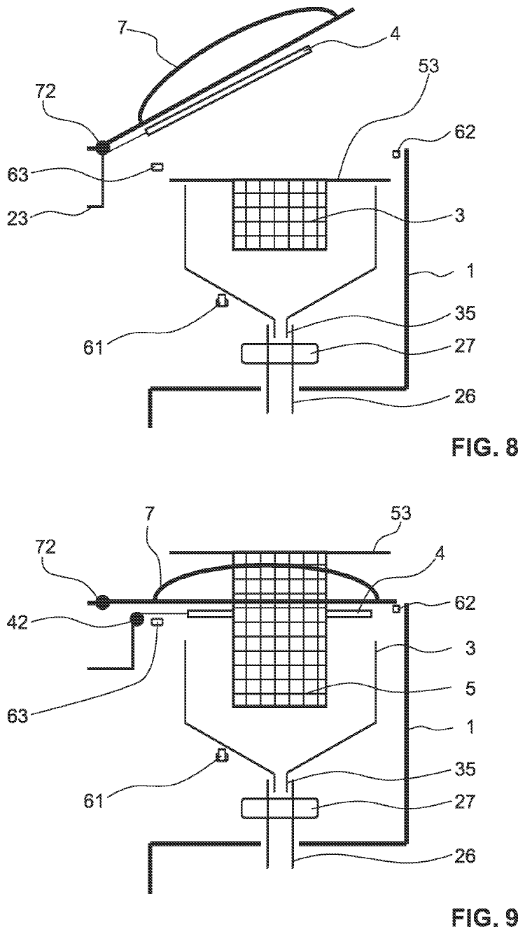

While separate hinges 42 and 72 are provided for the inlet device 4 and the lid 7 in the embodiment in FIG. 7, the inlet device 4 and the lid 7 are attached to the housing 1 via a common hinge 72 in the embodiment in FIG. 8. The inlet device 4 can here be firmly connected to the underside of the lid 7 or even form part of the lid 7.

FIG. 9 shows an embodiment in which the retaining sieve 5 can be inserted into the infusion vessel 3 from above through the lid 7 and the inlet device 4. In an alternative embodiment, it would also be possible for the lid 7 not to be attached to the housing 1 but to the retaining sieve 5.

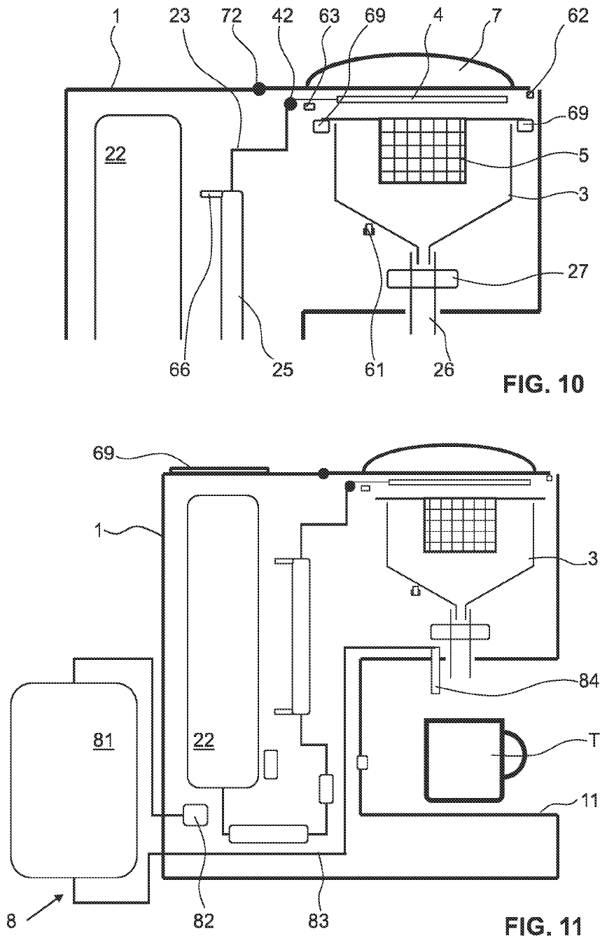

In the embodiment of FIG. 10, weight sensors 69 are additionally provided, which enable the infusion material to be weighed. The weight sensors 69 are connected to the control unit 6 and enable it, for example, to automatically adapt the preparation program to the quantity of the infusion material. The weighing of the infusion material can be carried out automatically, for example, as soon as the retaining sieve 5 is inserted into the infusion vessel 3 and/or before the beverage preparation is started.

In the embodiment of FIG. 11, a weight sensor 69 serving the same purpose is arranged on the upper side of the housing 1. The user has to place the infusion material contained in the retaining sieve 5 on the weight sensor 69 before the beverage is prepared.

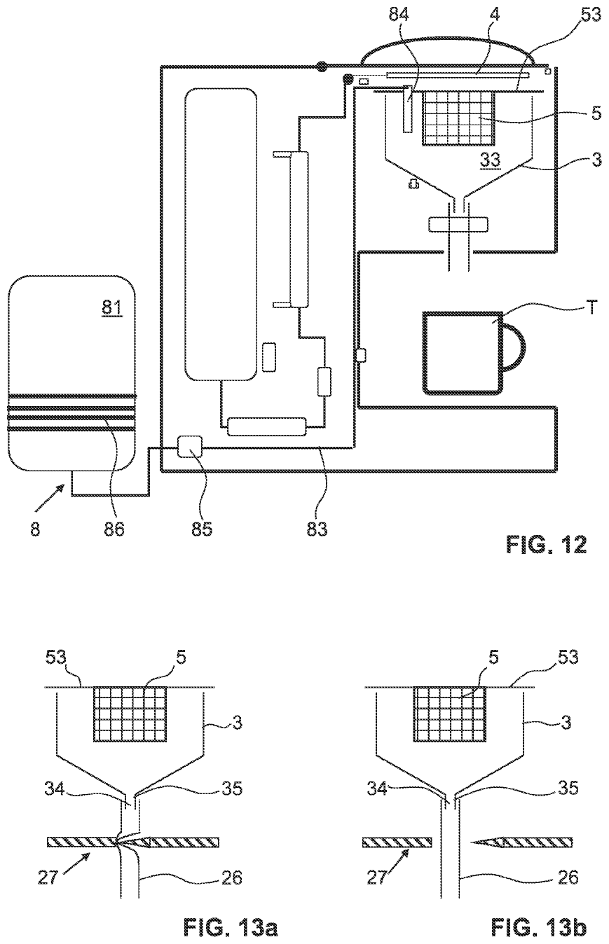

The embodiment of FIG. 11 also differs from that of FIG. 5 in that an additional preparation unit 8 is provided to supply an additional medium, such as milk or syrup concentrate, to the beverage recipient T. The additional preparation unit 8 has a container 81 for the additional medium, which is connected via a conduit 83 to an outlet piece 84, which is arranged above the storage surface 11 for the beverage recipient T. In order to convey the additional medium from the container 81 to the outlet piece 84, a compressed air pump 82 is provided, with which compressed air can be pumped into the container 81 as well as the conduit 83. Instead of the compressed air pump 82, a compressed air connection can also be provided to enable connection to an external compressed air system. In the embodiment shown in FIG. 12, a fluid pump 85 is provided instead of the compressed air pump 82 to convey the additional medium. This fluid pump is arranged within the conduit 83 between the container 81 for the additional medium and the outlet piece 84. The fluid pump 85 can be configured in particular as a peristaltic pump. In addition, the outlet piece 84 opens here into the interior space 33 of the infusion vessel 3. Furthermore, a heating or cooling device 86 is provided, which serves to temper the additional medium in the container 81.

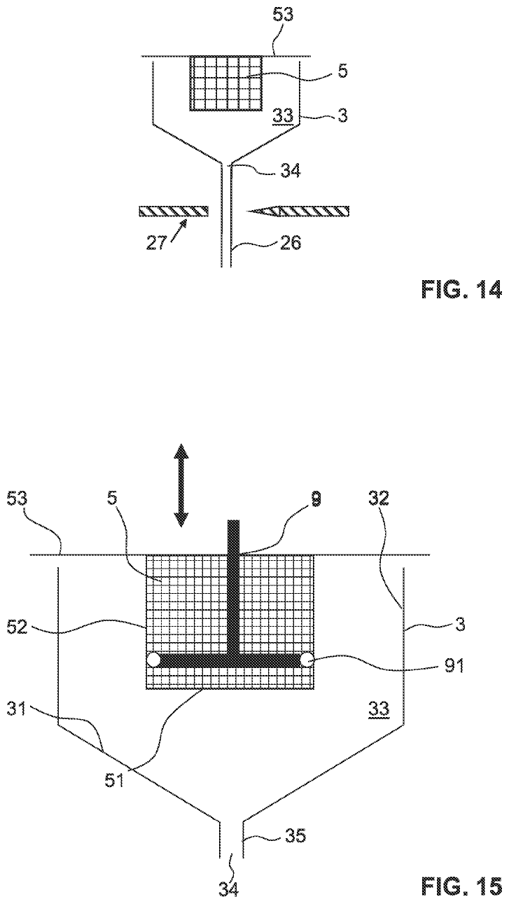

The design and function of an outlet valve 27 configured here as a pinch valve is illustrated in FIGS. 13a and 13b: In the locked state (FIG. 13a), the outlet conduit 26, which is formed by a flexible hose, is compressed and pinched off by a slider. In the open state (FIG. 13b), the slider is arranged at a distance from the outlet conduit 26, such that the passage through the outlet conduit 26 is free. An analogous situation is shown in FIG. 14, wherein here the outlet conduit 26 is firmly attached to the infusion vessel 3, for example welded thereto.

FIG. 15 shows an embodiment with an additional processing device in the form of a plunger 9, which is used for mechanical processing of the infusion material in the infusion vessel 3. The infusion material can be pressed out by pressing the plunger 9 down into the retaining sieve 5 along the direction of the arrow automatically by a motor or by hand. Such a processing device is particularly advantageous for the preparation of tea and herbal beverages. The plunger 9 has a radial circumferential seal 91 to prevent the infusion material from escaping upwardly during the pressing down operation.

Of course, the invention described here is not limited to the embodiments mentioned, and a variety of variations are possible. For example, the inlet device can also have only a single outlet opening in order to allow the liquid to flow into the infusion vessel 3 in a spiral shape. However, the outlet opening could just as well be annular, for example, so that the liquid is directed to the lateral inner surface 32 of the infusion vessel 3 without interruption.

Furthermore, in other embodiments, the retaining sieve can be replaced by any other holder or even omitted altogether. The infusion material could just as well be placed directly in the infusion vessel 3. Moreover, even if it is considered advantageous here, the infusion vessel could in other embodiments also be firmly connected to the housing 1 and thus not be removable therefrom. Instead of a water tank, the automatic machine could also have a water connection piece for connecting a hose from the mains water supply. As a further variant, the inlet device could also be formed by a lid for closing the infusion vessel or the retaining sieve, or even by the infusion vessel itself. A plurality of further variations is conceivable.

### LIST OF REFERENCES

| | | | |
|---|---|---|---|
| 1 | housing | 6 | control unit |
| 11 | storage surface | 61 | infusion vessel sensor |
| | | 62 | lid sensor |
| 2 | water treatment unit | 63 | inlet device sensor |
| 22 | water tank | 64 | beverage recipient sensor |
| 23 | water conduit | 65 | inlet temperature sensor |
| 24 | pump | 66 | outlet temperature sensor |
| 25 | heating or cooling device | 67 | water tank sensor |
| 26 | outlet conduit | 68 | flow meter |
| 27 | outlet valve | 69 | weight sensor |
| 3 | infusion vessel | 7 | lid |
| 31 | lower inner surface | 71 | opening |
| 32 | lateral inner surface | 72 | hinge for the lid |
| 33 | interior space | | |
| 34 | outlet opening | 8 | additional preparation unit |
| 35 | connection piece | 81 | container for additional |
| | | | medium |
| | | 82 | compressed air pump |
| 4, 4′ | inlet device | 83 | conduit |
| 41 | inlet opening | 84 | outlet piece |
| 42 | hinge for the inlet device | | fluid pump |
| | | 86 | heating or cooling device |
| 5 | holder, retaining sieve | 9 | plunger |
| 51 | bottom | 91 | seal |
| 52 | side wall | | |
| 53 | holding arm | T | beverage recipient |
| 54 | spacer | W | water flow |

1. An automatic machine for preparing infusion beverages, the automatic machine comprising:
a housing;
an infusion vessel insertable into the housing and having a lower inner surface and a lateral inner surface, which together define an interior space for receiving infusion material and water, and an outlet opening;
an outlet conduit connectable to the outlet opening and adapted to discharge an infusion beverage from the infusion vessel; and
an outlet valve adapted to block and unblock a discharge of the infusion beverage through the outlet conduit;
wherein the automatic machine comprises an inlet device adapted to admit liquid into the infusion vessel, the inlet device being configured such that the liquid flows uniformly over the lateral inner surface into the interior space of the infusion vessel.

2. The automatic machine of claim 1, wherein the automatic machine further comprises a holder for the infusion material, the holder being configured to be positioned in the interior space of the infusion vessel and wherein the holder serves to hold the infusion material during infusion in such a way that both the infusion material and the holder are arranged at a distance from the lower inner surface and from the lateral inner surface of the infusion vessel.

3. The automatic machine of claim 2, wherein the holder is configured as a retaining sieve comprising a bottom and a circumferential side wall extending upwardly from the bottom.

4. The automatic machine of claim 2, wherein one or more spacers are attached to the holder to ensure the spacing of the holder from the lateral inner surface or from the lower inner surface of the infusion vessel.

5. The automatic machine of claim 1, wherein the infusion vessel has a connection piece which is formed as the outlet opening and is configured to connect the outlet conduit thereto.

6. The automatic machine of claim 1, further comprising an infusion vessel sensor configured to detect whether the infusion vessel is correctly inserted in the housing, wherein the infusion vessel sensor comprises a mechanical or electromechanical sensor.

7. The automatic machine of claim 1, further comprising a lid adapted to close the infusion vessel and a lid sensor adapted to detect whether the lid is in an open state or a closed state.

8. The automatic machine of claim 1, wherein the inlet device has a plurality of inlet openings adapted to admit the liquid into the infusion vessel, the plurality of inlet openings being distributed at uniform intervals along the lateral inner surface of the infusion vessel.

9. The automatic machine of claim 1, wherein the inlet device is configured such that the liquid enters spirally over the lateral inner surface of the infusion vessel.

10. The automatic machine of claim 1, wherein the inlet device is configured to be opened and closed with respect to an upper side of the infusion vessel.

11. The automatic machine of claim 1, wherein an inlet device sensor is provided to detect the position of the inlet device with respect to the infusion vessel.

12. The automatic machine of claim 1, wherein the inlet device forms a lid adapted to close the infusion vessel.

13. The automatic machine of claim 1, wherein the infusion vessel comprises one or more of glass, ceramic, and a coated material and is a single piece.

14. The automatic machine of claim 1, additionally comprising a processing device adapted to mechanically process the infusion material in the infusion vessel.

15. The automatic machine of claim 1, wherein the inlet device comprises at least one inlet opening aligned with the lateral inner surface so that liquid flowing from the inlet opening to the lateral inner surface can wet the lateral inner surface before flowing into the interior space of the infusion vessel.

16. The automatic machine of claim 1, wherein the inlet device comprises a single inlet opening.

17. The automatic machine of claim 1, wherein the inlet device comprises a plurality of successively activatable inlet openings.

18. The automatic machine of claim 1, wherein the lateral inner surface has a wetting of from 60% to 100%.

19. (canceled)

20. The automatic machine of claim 1, wherein the housing includes a plurality of inlet devices.

21. A method of automatically cleaning an infusion vessel, the infusion vessel having a lower inner surface and a lateral inner surface which together define an interior space adapted to receive an infusion and water, wherein the method comprises:
providing an automatic machine according to claim 1,
introducing a liquid into the infusion vessel in such a way that the liquid flows uniformly and spirally over the lateral inner surface into the interior space of the infusion vessel.
